(19) United States
(12) Patent Application Publication
(10) Pub. No.: US 2008/0109786 A1
(43) Pub. Date: May 8, 2008

(54) Method and apparatus for analyzing structured document

(75) Inventors: Hideo Munechika, Yokohama (JP); Toshihiro Tsurugasaki, Yokohama (JP); Seirou Tamura, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/897,430

(22) Filed: Aug. 29, 2007

(30) Foreign Application Priority Data
Nov. 8, 2006 (JP) 2006-302984

(51) Int. Cl. G06F 9/44

(52) U.S. Cl. 717/112

(57) ABSTRACT

It is possible to realize a high-speed syntax analysis even when a different structured document is inputted to a job system each time. An analysis result table for holding a result of a syntax analysis of “a frequently appearing character string in the structured document” is added to an XML parse program which performs a syntax analysis of a structured document. The program includes a simple type element possibility judgment section, an analysis result extraction section, and an analysis result registration section. When a frequency appearing character string in a structured document appears for the second time or after during a syntax analysis, the analysis result extraction section extracts the stored element object from the analysis result table so as to be used again.

### INCORPORATION BY REFERENCE

The present application claims priority from Japanese application JP2006-302984 filed on Nov. 8, 2006, the content of which is hereby incorporated by reference into this application.

### BACKGROUND OF THE INVENTION

1. Field of the Invention

The present invention relates to a method and a device or an apparatus for analyzing a structured document and in particular, to a method and a device for analyzing a structured document capable of performing syntax analysis of the structured document at a high speed.

2. Description of the Related Art

A conventional technique for performing syntax analysis of a structured document is disclosed, for example, in JP-A-2004-62716. In this conventional technique, a result of syntax analysis of whole structured document is held in a cache for syntax analysis of a structured document and when a syntax analysis of a structured document held in the cache is requested from an application, the result of syntax analysis held in the cache is returned without performing syntax analysis of the structured document, thereby realizing a high-speed syntax analysis.

### SUMMARY OF THE INVENTION

In the structured document syntax analysis method according to the conventional technique, the unit held in a cache is a structured document unit and accordingly, the content of the cache can be applied only to the structured document having the same content. For this, in the aforementioned conventional technique, a syntax analysis using the cache cannot be performed if the content of the structured document as a syntax analysis object has a content different from the syntax analysis result held in the cache.

In general, the structured document processing in a job system often handles a different structured document each time. When the conventional technique is applied to such a job system, it becomes almost impossible to use a cache and there arises a problem that it is impossible to realize a high-speed syntax analysis process.

It is therefore an object of the present invention to provide a method and a device for analyzing structured document capable of performing a high-speed syntax analysis even when a syntax analysis of a different structured document is to be performed each time.

According to the present invention, the aforementioned object can be achieved by a structured document syntax analysis method to be used in a syntax analysis device comprising syntax analysis means, the syntax analysis device including simple type element possibility judgment means, analysis result extraction means, analysis result registration means, and analysis result storage means for storing an analysis result, wherein the analysis result registration means extracts a frequently appearing character string having a predetermined structure defined by the structured document analyzed by the syntax analysis means, stores the frequently appearing character string and the analysis result of the frequently appearing character string in the analysis result storage means; the simple type element possibility judgment means recognizes and cuts out a character sting having a possibility of a frequently appearing character string from the structured document inputted to the syntax analysis device; and the analysis result extraction means extracts an analysis result of the corresponding frequently appearing character string from the analysis result storage means and outputs the analysis result.

The present invention can reduce the number of execution times of the element lexical unit analysis process, the element character check process, and the element object generation process. This enables a high-speed syntax analysis of a structured document.

### BRIEF DESCRIPTION OF THE DRAWINGS

FIG. 1 is a block diagram explaining configuration of a structured document analysis device for XML document according to an embodiment of the present invention.

FIGS. 2A and 2B explain an “element” in the XML document.

FIG. 3 shows a SOAP message as an example of an input XML document of the job system.

FIG. 4 shows a detailed configuration example of an analysis result table.

FIG. 5 is a flowchart explaining a processing operation of an XML parse program initialization section.

FIG. 6 is a flowchart explaining the processing operation of a simple type element possibility judgment section.

FIG. 7 is a flowchart explaining the processing operation for judging whether the character string read in step 602 of the flow shown in FIG. 6 may be a simple type element.

FIG. 8 is a flowchart explaining the processing operation of an analysis result acquisition section.

FIG. 9 is a flowchart explaining the processing operation of an analysis result registration section.

### DESCRIPTION OF THE EMBODIMENTS

Firstly, explanation will be given on an outline of the embodiment of the present invention. According to the embodiment of the present invention, for the syntax analysis device for structured document, a syntax analysis result of “a frequently appearing character string in the structured document” is stored in a table as the analysis result storage means so that when the character string appears at a second time or after, the syntax analysis result stored in the table is reused.

In general, the same character string repeatedly appears in a structured document as the job system input and a common character string often appears in a plurality of different structured documents as the job system input. The embodiment of the present invention pays attention on this characteristic of the structured document as the job system input.

More specifically, the content of the frequently appearing character string differs according to the type of the structured document (XML, HTML, SGML, etc.) and the use (slip, message, table, etc.) of data expressed by the structured document. For example, in the XML document as one of the types of the structured document, a simple type element such as a tag name and a text in the form of a fixed character string and an attribute having an attribute name and an attribute value expressed as a fixed character string may be the frequently appearing character strings. It should be noted that the simple type element is the simple type defined by “the W3C Recommendation XML Schema Part 0, Part 1, Part 2” which is applied to an element and it is a general concept in the technical field of the XML.

Hereinafter, detailed explanation will be given on the method and the device for analyzing structured document according to an embodiment of the present invention with reference to the attached drawing. It should be noted that the embodiment of the present invention explained below is a case using the XML document as the structured document.

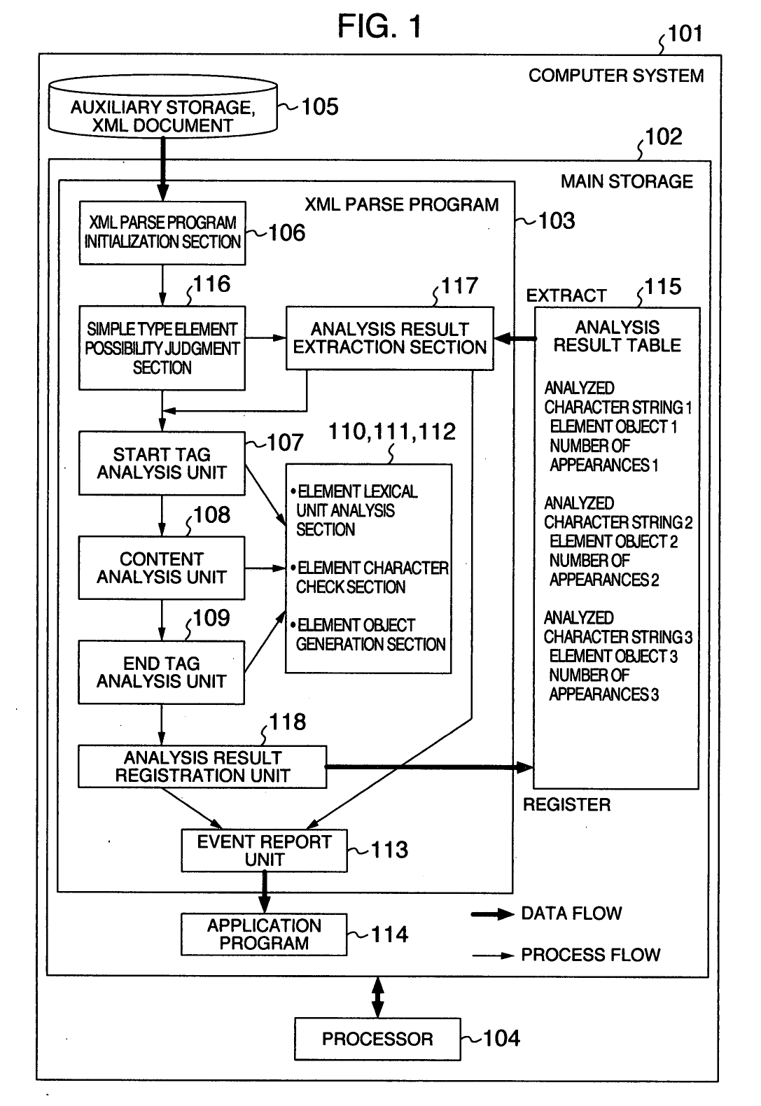

FIG. 1 is a block diagram explaining a configuration of the XML document syntax analysis device and its I/O data according to the embodiment of the present invention. In FIG. 1, 101 denotes a computer system, 102 denotes a main storage device, 103 denotes an XML parse program, 104 denotes a processor, 105 denotes an auxiliary storage device, 106 denotes an XML parse program initialization section, 107 denotes a start tag analysis section, 108 denotes a content analysis section, 109 denotes an end tag analysis section, 110 denotes an element lexical unit analysis section, 111 denotes an element character check section, 112 denotes an element object generation section, 113 denotes an event notification section, 114 denotes an application program, 115 denotes an analysis result table, 116 denotes a simple type element possibility judgment section, 117 denotes an analysis result extraction section, and 118 denotes an analysis result registration section.

The XML document syntax analysis device according to the embodiment of the present invention is configured in the computer system 101. As is well known, the computer system 101 includes the main storage device 102, the processor 104 as a CPU for controlling the entire process of the computer system 101 and executing a program provided for the present invention, the auxiliary storage device 105 such as a hard disc device, input devices such as a keyboard and a mouse and output devices such as a display device and a printer (not depicted).

The main storage device 102 contains: the XML parse program 103 for performing syntax analysis of the structured document loaded from the auxiliary storage device 105 so as to be subjected to the process of the present invention, and the analysis result table 115. The XML parse program 103 is executed by the processor 104. the XML document stored in the auxiliary storage device 105 is inputted to the XML parse program 103 and the XML parse program 103 executes syntax analysis of the XML document.

The XML parse program 103 is formed by the XML parse program initialization section 106, the start tag analysis section 107, the content analysis section 108, the end tag analysis section 109, the element lexical unit analysis section 110, the element character check section 111, the element object generation section 112, the event notification section 113, the application program 114, the simple type element possibility judgment section 116, the analysis result extraction section 117, and the analysis result registration section 118. The aforementioned start tag analysis section 107, the content analysis section 108, and the end tag analysis section 109 constitute the syntax analysis section.

When an ordinary XML parse program executes syntax analysis of “element” which is one of the basic units of the XML document, the program successively calls the start tag analysis section, the content analysis section 108, and the end tag analysis section 109 from the XML parse program initialization section 106.

The start tag analysis section 107, the content analysis section 108, and the end tag analysis section 109 all call the element lexical unit analysis section 110, the element character check section 111, and the element object generation section 112. The element lexical unit analysis section 110 executes lexical unit analysis of the element start tag and the end tag. The lexical unit analysis is a process for decomposing a character string contained in the XML document into “<”, “>”, and the other portion. The element character check section 111 checks whether a character contained in the element is matched with a character defined in the XML specification. The element object generation section 112 converts the syntax analysis result of the start tag, the content, and the end tag into element objects appropriate to be passed to the application program 114. The element objects are passed to the application program via the event report section 113. These processes in the element lexical unit analysis section 110, the element character check section 111, and the element object generation section 112 require a plenty of time.

The embodiment of the present invention is formed by adding the simple type element possibility judgment section 116, the analysis result extraction section 117, and the analysis result registration section 118 to the configuration of the aforementioned ordinary XML parse program and by adding the analysis result table 125 to the main storage 102.

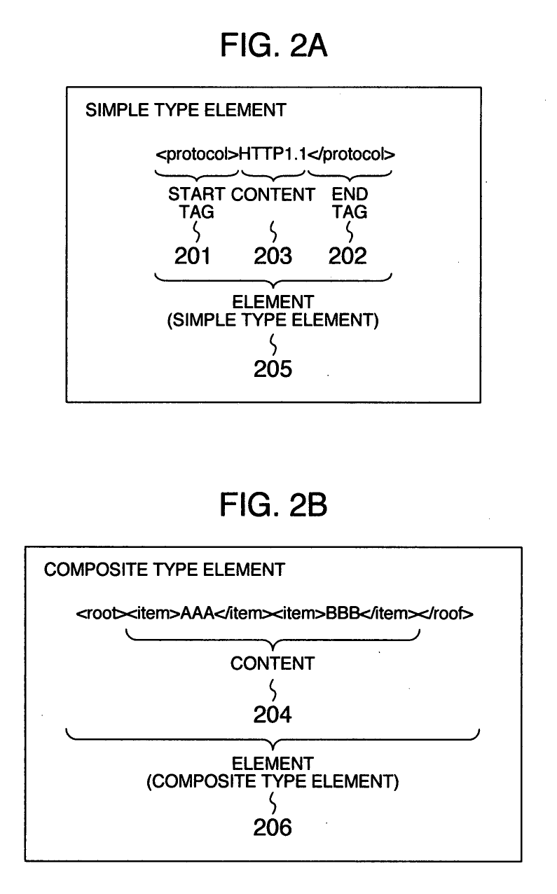

FIGS. 2A and 2B explain the “element” in the XML document. As shown in FIG. 2A, the element starts with a start tag 201 and ends with an end tag 202. A content 203 may be contained between the start tag and the end tag. The content may be only a text like the content 203 or may include elements inside like a content 204 in FIG. 2B. In the explanation below, the element having the content containing only a text as shown in FIG. 2A will be called a simple type element 205 and the other elements including the element having elements in the content as shown in FIG. 2B will be called a composite type element 206.

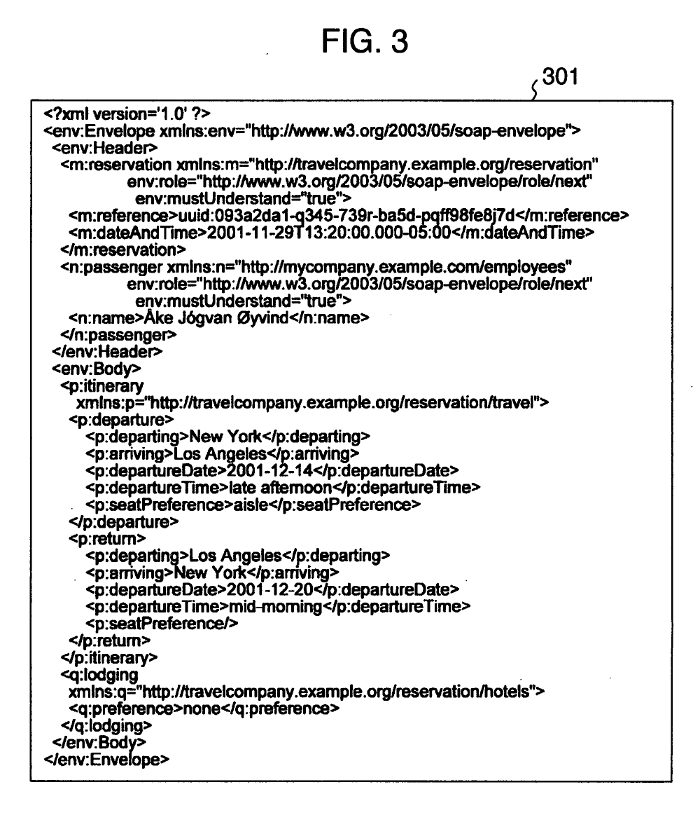

FIG. 3 shows a SOAP message as an example of the job system input XML document. The SOAP message 301 shown in FIG. 3 is cited from “Example 1” of “2.1 SOAP Messages” of “W3C Recommendation SOAP Version 1.2 Part 0: Primer”.

This SOAP message 301 is enclosed by <env:Envelope> and </env:Envelope> and expresses one record of a seat reservation for an aircraft. Moreover, this SOAP message is divided into two parts. The first part is enclosed by <env:Header> and </env:Header> and called a SOAP header. The SOAP header indicates that this XML document is a SOAP message and contains a seat reservation ID, the time when the reservation is made, the name of staff who made the reservation, and the like. The second part is enclosed by <env:Body> and </env:Body> and called a SOAP body. The SOAP body contains a departing position, an arriving position, a departure date, departure time band, a seat position, and the like for each of outgoing aircraft and coming back aircraft.

Not only the job system using the SOAP but also the job system using the XML in B2B or the like receive several hundreds to several tens of thousands of the messages as shown in FIG. 3 and cause the XML parse program to process the messages.

In the example of FIG. 3, the SOAP header portion is unique to each message. However, many of the simple type elements constituting the SOAP body are common to a plurality of messages. For example, the simple type element <p:departing>New York</p:departing> is contained in all the SOAP body containing the information that the departing position is New York. Moreover, the simple type element <p:seatPreference>aisle</p:seatPreference> is contained in all the SOAP body containing the information that “the seat is at the aisle side”.

As has been explained in the example, the simple type element in the XML document represents “data not having a hierarchical structure” such as a departing position and an arriving position. Since “the data not having a hierarchical structure” is the most basic data constituting the XML document, the probability that the same simple type element repeatedly appears in one or more XML documents is higher than the probability that “data having a hierarchical structure” appears repeatedly. The embodiment of the present invention utilizes the characteristic that the simple type element frequently appears in the XML document and stores the analysis result in the analysis result table 115 so as to reduce the time required for analyzing the simple type element which frequently appears.

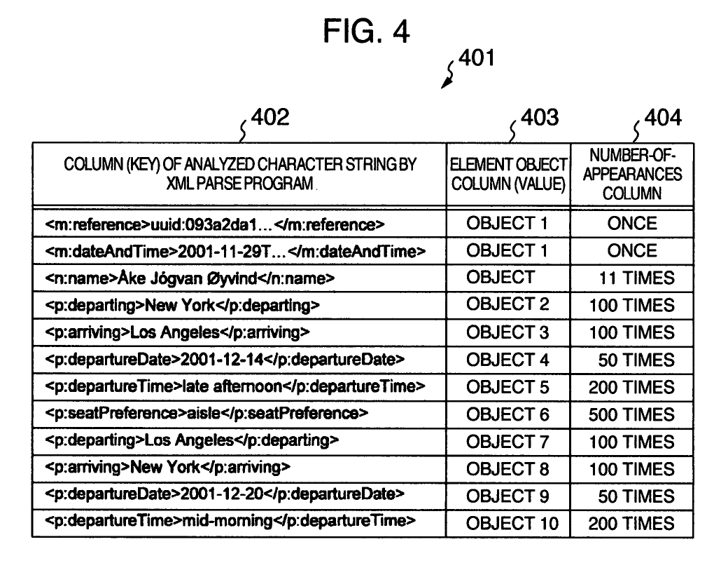

FIG. 4 is a table showing a detailed configuration example of the analysis result table. The analysis result table 115 is formed by an analyzed character string column 402 by the XML parse program containing the printing surface of the simple type element which has been analyzed, an element object column 403 for storing an object generated as an analysis result of the simple type element, and a number-of-appearances column 404 for storing the count result of the number of appearances of the same simple type element. Registration into the analysis result table 115 and search of the table are performed by using the analyzed character string column 402 by the XML parse program as a key. The element object column 403 has a value corresponding to a value of the number-of-appearances column 404.

In the embodiment of the present invention, the XML parse program 103 shown in FIG. 1 performs syntax analysis of an XML document by registering a value in each of the columns of the analysis result table 115 and searching a value.

Next, explanation will be given on the outline of the processing operation in the XML document syntax analysis device according to the embodiment of the present invention with reference to FIG. 1. A specific explanation will be given on the high-speed processing.

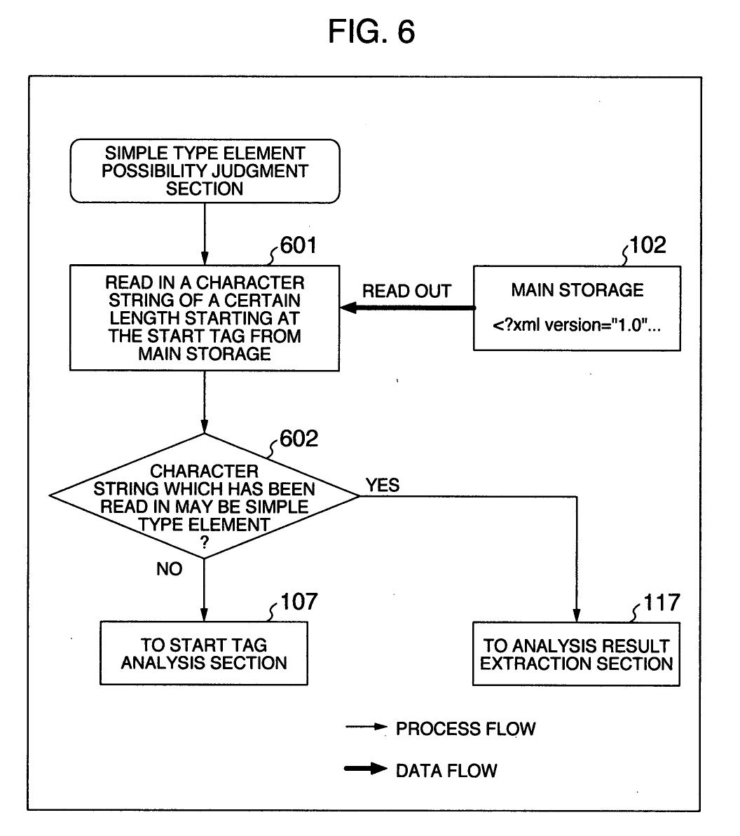

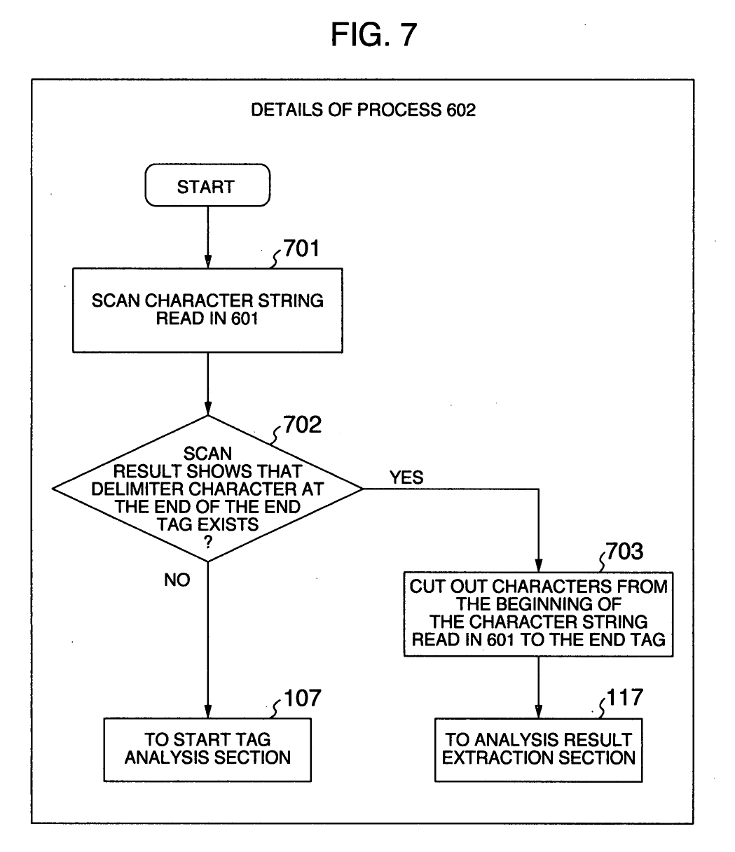

Firstly, the XML parse program initialization section 106 reads the XML document from the auxiliary storage device 105 into the main storage device 102. Next, the simple type element possibility judgment section 116 checks whether the XML document element which has been read in may be a simple type element registered in the analysis result table 115 (details of this check will be explained later with reference to FIG. 6 and FIG. 7). The simple type element possibility judgment section 116 performs the check to identify one of the following three conditions and repeatedly performs the check until all the elements are read in.

(1) The element to be processed has no possibility to be a simple type element to be registered in the analysis result table.

(2) The element to be processed has the possibility to be a simple type element to be registered in the analysis result table and the element is not yet registered in the table.

(3) The element to be processed has the possibility to be a simple type element to be registered in the analysis result table and the element is already registered in the table.

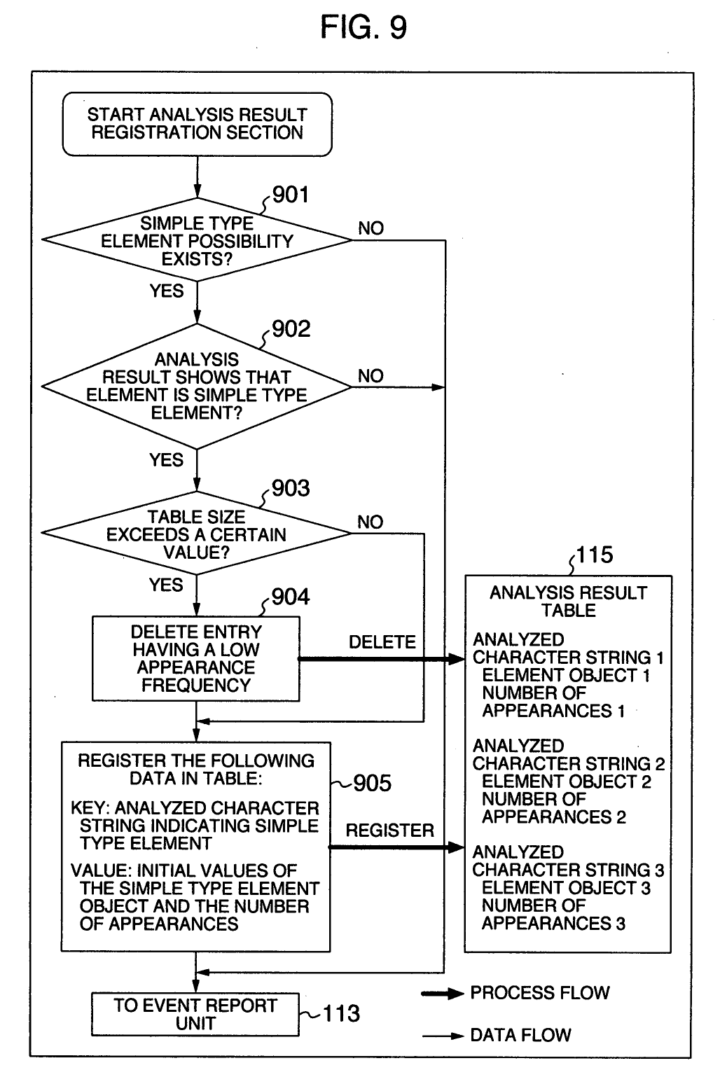

The aforementioned (1) is a case that the element to be processed “has no possibility to be a simple type element to be registered in the analysis result table”. In this case, the simple type element possibility judgment section 116 will not make a judgment of possibility of the simple type element (judged to be NO in step 602 of the flowchart which will be detailed later with reference to FIG. 6). From the start tag to the end tag, processes are performed in the element lexical unit analysis section 110, the element character check section 111, and the element object generation unit 112. After this, when the process (which will be detailed later with reference to the flowchart of FIG. 9) in the analysis result registration section 118 is executed, the simple type element possibility judgment process (step 901 in the flowchart of FIG. 9) is again performed and judgment of NO is made. The processes of the steps 902 to 905 in the flowchart of FIG. 9 are skipped and the process of the event report section 113 of the element object to the application program 114 is executed. In this case (1), the process is not performed at a high speed as compared to a general XML parse program.

The aforementioned (2) is a case that the element to be processed “has the possibility to be a simple type element to be registered in the analysis result table and the element is not yet registered in the analysis result table”. In this case, the simple type element possibility judgment section 116 makes a judgment of possibility of the simple type element (judged to be YES in step 602 of the flowchart shown in FIG. 6). The analysis result extraction section 117 acquires an element object from the analysis result table 115 by using the simple type element as the key. In this element object acquisition process, if acquisition of the analysis result fails, from the start tag to the end tag, processes are performed in the element lexical unit analysis section 110, the element character check section 111, and the element object generation section 112.

After this, when the process (which will be detailed later with reference to FIG. 9) in the analysis result registration section 118 is executed, the simple type element possibility judgment process (step 901 in the flowchart of FIG. 9) is executed and judgment of YES is made. As a result of judgment of YES, next, it is judged whether the element is really a simple type element from the analysis result of the element processed here. If the element being processed is a simple type element (YES in judgment of step 902 of the flowchart of FIG. 9), it is judged whether the size of the analysis result table 115 exceeds a predetermined size (step 903 in the flowchart of FIG. 9. If YES, the entry of the lowest number of appearances is deleted (step 904 in the flowchart of FIG. 9). Next, an element object is registered into the analysis result table 115 by using the simple type element as the key (step 905 of the flowchart in FIG. 9). Simultaneously with this, the number-of-appearances column 404 in the analysis result table 115 is initialized. If the element being processed is not a simple type element (NO in the judgment of step 902 of the flowchart shown in FIG. 9), the element need not be registered in the analysis result table 115 and the processes of steps 903 to 905 are skipped. After this, regardless of the simple type element, the process in the event report section 113 as the event report process of the element object to the application program 114 is executed. In this case (2) also, the process is performed not at a high speed as compared to the ordinary XML parse program.

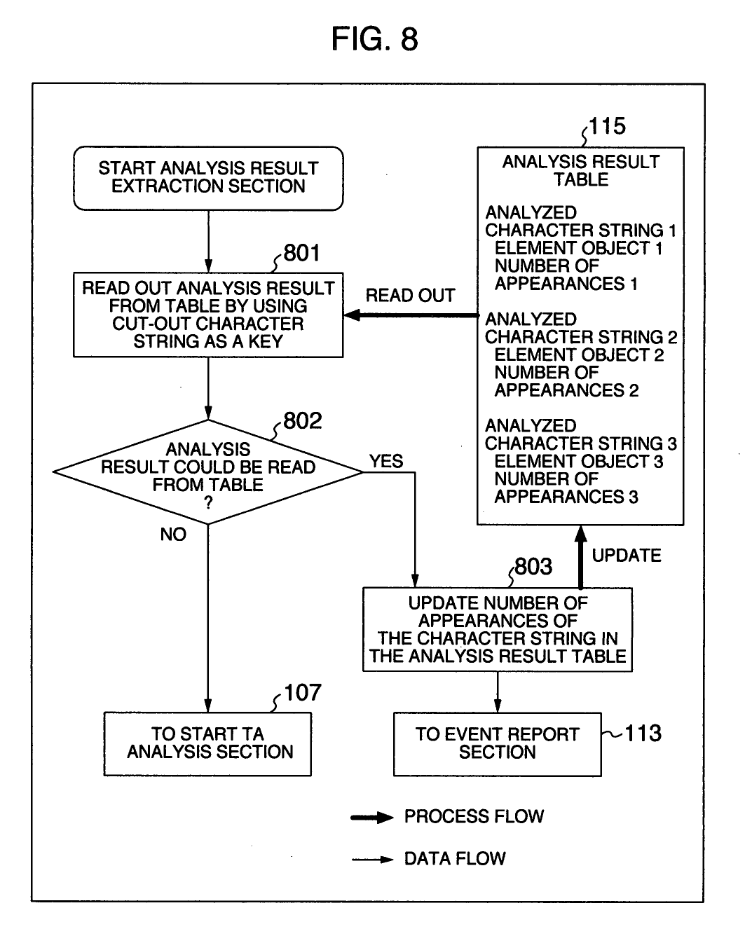

The aforementioned (3) is a case that acquisition of the element object from the analysis result table 115 is successful during the process of the aforementioned process (2) (judged to be YES in step 802 of the flowchart shown in FIG. 8). In this case, the number-of-appearances column 404 in the analysis result table 115 is updated (step 803 in the flowchart of FIG. 8) and then by using the acquired element object, the process in the event report section 113 as the event report process of the element object to the application program 114 is executed. In this case (3), since the processes in the element lexical unit analysis section 110, the element character check section 111, and the element object generation section 112 are skipped from the start tag to the end tag, the process is performed at a high speed as compared to the ordinary XML parse program.

As has been described above, in the XML document inputted to a job system, the same simple type element often appears repeatedly and the probability that the aforementioned (3) is executed is higher than the probability that (1) and (2) are performed. Accordingly, the XML parse program according to the embodiment of the present invention can perform the XML document syntax analysis at a higher speed than the ordinary XML parse program.

It should be noted that the number-of-appearances column 404 of the analysis result table is used to suppress the memory size of the analysis result table to a certain value. That is, when the analysis result table 115 exceeds a certain size, the entry of the lowest number-of-appearances is deleted (step 904 of the flowchart shown in FIG. 9). Thus, it is possible to increase the speed of the syntax analysis process and suppress the memory size.

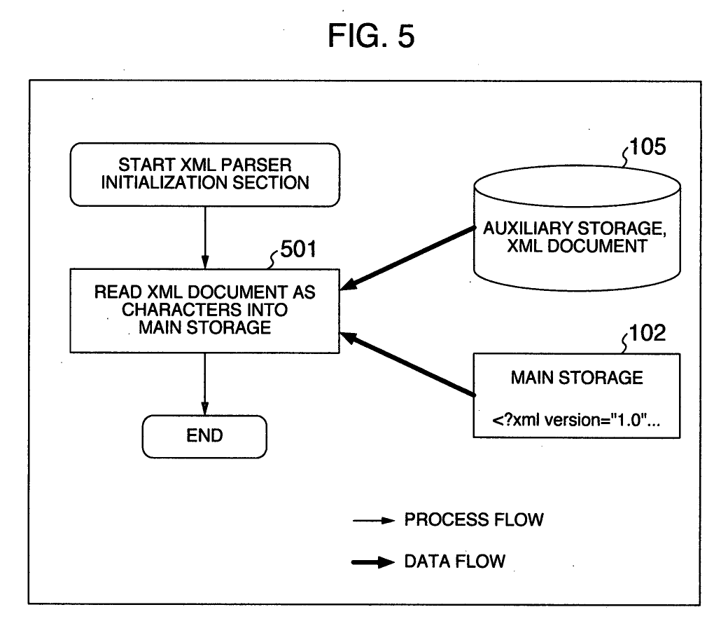

FIG. 5 is a flowchart explaining the process operation of the XML parse program initialization section 106. The process of the XML parse program initialization section 106 here is performed as follows. When the process of initialization is started, an XML document is read in from the auxiliary storage device 105 and stored as a character in the main storage device 102 (step 501).

FIG. 6 is a flowchart explaining the process operation of the simple type element possibility judgment section 116. Next, explanation will be given on this.

(1) When this process is started, the simple type element possibility judgment section 116 reads in a character string of a predetermined length starting at the start tag from the main storage device 102 (step 601).

(2) It is judged whether the character string actually read in the process of step 601 may be a simple type element. It should be noted that details of the judgment process here will be explained later with reference to FIG. 7 (step 602).

(3) If step 602 judges that the character string which has been read in may be a simple type element, the process is passed to the analysis result extraction section 117. If the character string which has been read in may not be a simple type element, the process is passed to the start tag analysis section 107.

FIG. 7 is a flowchart explaining the process operation for judging whether the character string which has been read in step 602 of the flowchart shown in FIG. 6 may be a simple type element. Next, explanation will be given on this.

(1) When this process is started, the character string which has been read in the process of step 601 is scanned (step 701).

(2) After performing scanning in the process of step 701, it is judged whether a delimiter character at the end of the end tag exists. If no delimiter character of the end tag exists, it is judged that there is no possibility of the simple type element and the process is passed to the start tag analysis section 107 (step 702).

(3) If step 702 judges that a delimiter character of the end tag exists, it is judged that there is a possibility of the simple type element and a portion from the beginning of the character string which has been read to the delimiter character of the end tag is cut out. After this, the process is passed to the analysis result extraction section 117.

The reason why it is necessary to limit the number of characters to be read in the process of step 601 is as follows.

When a character string is long, it may be a composite type element of a simple type element containing a long content. If it is a composite type element, it is not to be registered in the analysis result table and it is judged that “no possibility exists”. Moreover, a simple type element having a long content is a non-typical element having a high possibility that it does not appear frequently. Accordingly, in this case also, it is judged that “no possibility exists”.

For this, in the process of the aforementioned step 601, the length of the character string to be read is limited to a certain length so that even in a case of a simple type element and the character string of the content between the start tag and the end tag is longer than a certain length, it need not be treated as a simple type element in the embodiment of the present invention. The same applies to the process in the analysis result registration section 118 which will be detailed later. When the character string of the content between the start tag and the end tag is longer than a certain length, it is not stored in the analysis result table 115.

As a method for deciding a threshold value as a certain length, it is possible to store all the lengths of 100 simple type elements after starting the parse of the XML document and extract the middle value of the simple type elements or it is possible to use a method for making a decision according to a specification by a user.

The process of the simple type element possibility judgment section 116 does not accurately judge whether the element being read is a simple type element but only whether the element has the possibility to be a simple type element registered in the analysis result table 115. Accordingly, even if the element is judged to have the possibility to be a simple type element, it may not be a simple type element registered in the analysis result table 115 in the end.

However, without using the process of the simple type element possibility judgment section 116, it is possible to judge whether an element is a simple type element by performing a check of normally used element analysis means, i.e., a nested structure of the start tag, content, and the end tag and an XML constituting character for all the characters constituting the element. The normally used element analysis means has a problem that the processing cost is high as compared to a simple process of the simple type element possibility judgment section 116. Accordingly, as compared to the aforementioned conventional technique, it is more effective to judge whether the element being read is a simple type by using the process of the simple type element possibility judgment section 116.

As has been described above, by storing the analysis result of the frequently appearing character string in the analysis result table 115 so that it can be used repeatedly, it is possible to skip the lexical unit analysis process of the element, the element character check process, and the element object generation process concerning the frequently appearing character string. Since these processes require a plenty of time, the embodiment of the present invention can realize a high-speed syntax analysis process.

FIG. 8 is a flowchart explaining the processing operation of the analysis result extraction section 117. Next, explanation will be given on this process. This process is started when the simple type element possibility judgment section 116 judges that the element to be processed has the possibility to be a simple type element to be registered in the analysis result table.

(1) When the process is started, the analysis result extraction section 117 searches the analysis result table 115 by using the extracted character string as a key and reads out the analysis result from the analysis result table 115 (step 801).

(2) It is judged whether the analysis result could be read from the analysis result table 1156. If no analysis result could read out, the process is passed to the start tag analysis section so as to perform syntax analysis of the cut-out character string (step 802).

(3) If step 802 judges that an analysis result could be read out, 1 is added to the value of the number-of-appearances column 404 of the corresponding character string in the analysis result table 115 so as to update the value and the value of the element object column 403 is passed to the event report section 113 (step 803).

FIG. 9 is a flowchart explaining the processing operation of the analysis result registration section 118. Next, explanation will be given on this process. This process is started when a syntax analysis of the cut-out character string is performed by the process in the start tag analysis section 107, the content analysis section 108, and the end tag analysis section 109.

(1) When a process is started, the analysis result registration section 118 firstly judges whether the element as the analyzed character string has the possibility to be a simple type element. If the element has no possibility to be a simple type element, the process is passed to the event report section 113 (step 901).

(2) When the step 901 judges that the element has the possibility to be a simple type element, it is judged whether the element was a simple type element according to the element analysis result. If the element was not the simple type element, the process is passed to the event report section 113 (step 902).

(3) When the step 902 judges that the element is a simple type element, it is judged whether the size of the analysis result table 115 exceeds a certain size after containing the analysis result of the corresponding element (step 903).

(4) When the step 903 judges that the size of the analysis result table 115 exceeds a predetermined size, the entry having the lowest appearance frequency in the analysis result table 115 is deleted (step 904).

(5) After the process of step 904 or when the step 903 judges that the size of the analysis result table 115 does not exceed the predetermined size, the received analysis result is stored in the analysis result table 115. That is, the analyzed character string expressing a simple type element is stored in the column 402 of the character string serving as the key, the object of the simple type element is stored in the element object column 403, and the initial value 1 is stored as the number of appearances is stored in the number-of-appearances column 404. After this, the process is passed to the event report section 113 (step 905).

The respective processes in the embodiment of the present invention are configured by programs which can be executed by a CPU owned by the present invention. Moreover, the programs may be provided by storing them in a recording medium such as an FD, a CDROM, and a DVD. Furthermore, the programs may be provided by digital information via a network.

It should be further understood by those skilled in the art that although the foregoing description has been made on embodiments of the invention, the invention is not limited thereto and various changes and modifications may be made without departing from the spirit of the invention and the scope of the appended claims.

1. A structured document syntax analysis method to be used in a syntax analysis apparatus comprising syntax analysis means,
the syntax analysis apparatus including simple type element possibility judgment means, analysis result extraction means, analysis result registration means, and analysis result storage means for storing an analysis result,
wherein the analysis result registration means extracts a frequently appearing character string having a predetermined structure defined by the structured document analyzed by the syntax analysis means, stores the frequently appearing character string and the analysis result of the frequently appearing character string in the analysis result storage means; the simple type element possibility judgment means recognizes and cuts out a character sting having a possibility of a frequently appearing character string from the structured document inputted to the syntax analysis apparatus; and the analysis result extraction means extracts an analysis result of the corresponding frequently appearing character string from the analysis result storage means and outputs the analysis result.

2. The structured document syntax analysis method as claimed in claim 1, wherein the analysis result extraction means passes the frequently appearing character string to the syntax analysis means if no analysis result of the corresponding frequently appearing character string can be extracted from the analysis result storage means.

3. The structured document syntax analysis method as claimed in claim 1, wherein the structured document is an XML document and the frequently appearing character string is a simple type element.

4. The structured document syntax analysis method as claimed in claim 3, wherein the analysis result storage means stores a pair of an analyzed character string indicating a simple type element as a key and an element object as an analysis result of the element.

5. The structured document syntax analysis method as claimed in claim 3, wherein the simple type element possibility judgment means recognizes and cuts out a character string having a possibility of a simple type element by confirming existence of a delimiter character of a start tag and an end tag and cutting out them from the character string of the structure document.

6. The structured document syntax analysis method as claimed in claim 3, wherein the simple type element possibility judgment means recognizes a character string having a possibility of a simple type element but does not perform cutting out of the character string if the content of the simple type element exceeds a predetermined length.

7. The structured document syntax analysis method as claimed in claim 3, wherein the analysis result storage means further contains the number of times when the analyzed character string indicating the simple type element as a key and its analysis result have been extracted to be used; and the analysis result registration means stores the simple type element of the structured document analyzed by the syntax analysis means and its analysis result in the analysis result storage means by deleting the one having the smallest number of uses if the analysis result storage means exceeds a predetermined size.

8. A structured document syntax analysis device comprising syntax analysis means,
the syntax analysis device including simple type element judgment means, analysis result extraction means, analysis result registration means, and analysis result storage means for storing an analysis result,
wherein the analysis result registration means extracts a frequently appearing character string having a predetermined structure defined by the structured document analyzed by the syntax analysis means, stores the frequently appearing character string and the analysis result of the frequently appearing character string in the analysis result storage means; the simple type element possibility judgment means recognizes and cuts out a character sting having a possibility of a frequently appearing character string from the structured document inputted to the syntax analysis device; and the analysis result extraction means extracts an analysis result of the corresponding frequently appearing character string from the analysis result storage means and outputs the analysis result.

9. A structured document syntax analysis program comprising a syntax analysis process, a simple type element possibility judgment process, an analysis result extraction process, an analysis result registration process, and analysis result storage means for storing an analysis result,
wherein the analysis result registration process has a step for extracting a frequently appearing character string having a structure defined by the structured document analyzed by the syntax analysis process and a step for storing the frequently appearing character string and an analysis result of the frequently appearing character string in the analysis result storage means,
the simple type element possibility judgment process has a step for recognizing a character string having a possibility of a frequently appearing character string and cutting out from the structured document inputted to the syntax analysis apparatus, and
the analysis result extraction process has a step for extracting an analysis result of the corresponding frequently appearing character string from the analysis result storage means by using the recognized character string having the possibility of the frequently appearing character string as a key, and a step for outputting the analysis result, and
the program causes a processor of a computer system to execute the respective steps.
